(19) United States
(12) Patent Application Publication
(10) Pub. No.: US 2016/0015044 A1
(43) Pub. Date: Jan. 21, 2016

(54) WHOLE CAKE CUTTING DEVICE

(71) Applicant: Julieta Sy, Sanford, FL (US)

(72) Inventor: Julieta Sy, Sanford, FL (US)

(21) Appl. No.: 14/333,716

(22) Filed: Jul. 17, 2014

(51) Int. Cl. A21C 15/04; B26B 3/04

(52) U.S. Cl. CPC A21C 15/04; B26B 3/04

(57) ABSTRACT

A whole cake cutting device includes a continuous outer wall having a top edge, a bottom edge, an inside facing surface and an outside facing surface that define a hollow interior space. A plurality of cutting elements are positioned within the hollow interior space of the outer wall and include a knife edge bottom edge.

### TECHNICAL FIELD

The present invention relates generally to cutting devices, and more particularly to a cutting device for cakes and other such confections in order to create a plurality of evenly sized pieces.

### BACKGROUND

The statements in this section merely provide background information related to the present disclosure and may not constitute prior art.

Baked cakes have been popular confections for centuries and their manner of preparation has changed only slightly in that time. As a baked product, the cake has a relatively solid consistency which allows bakers and/or cake decorators to apply any number of decorative features such as painting images with frosting or separating layers of cake with frosting. For more formal events such as weddings, for example, bakers may combine several different cakes into a single tiered structure wherein each cake is separated by support columns which are usually inedible. This has led to cakes in modern times to be seen as both a tasty treat and a decorative piece tailored to the celebration at which it is presented.

In recent years, there have been many new approaches to applying decorations to cakes, for example, recent advances in technology have created edible paper and inks which can be computer printed to create any number of different shapes, pictures and colors, for example. However, despite these advances, the process of actually cutting the finished cake has remained largely unchanged.

In this regard, the baker, server or customer must ultimately utilize a knife to slice the whole cake into several pieces before it can be served. Depending on the skill of the cake cutter, it is not uncommon for the cake to be cut unevenly, resulting in pieces that are too big or too small. In many instances, this inability to cut the cake evenly results in an appropriately sized whole cake being unable to feed the number of people for which it was prepared.

In addition to the above, even when the cake cutter is skilled at creating evenly sized pieces, they are, at most, only able to cut the cake into squares. Although appetizing, the cut pieces are not able to convey the decorative/artistic elements of the overall cake.

Accordingly, there remains a need for a device capable of cutting a plurality of evenly sized pieces of a confection in any number of different shapes, that does not suffer from the drawbacks of the devices described above.

### SUMMARY OF THE INVENTION

The present invention is directed to a cake cutting device. One embodiment of the present invention can include a continuous outer wall having a top edge, a bottom edge, an inside facing surface and an outside facing surface that define a hollow interior space. A plurality of cutting elements can be positioned within the hollow interior space of the outer wall and can function to impart a cutting force onto a cake.

In another embodiment of the invention, each of the cutting elements can be cross connected so as to cut an entirety of the cake. Each of the cutting elements can include a generally straight shape, or can be wavy in nature, so as to create cake pieces in a plurality of different shapes and sizes.

Yet another embodiment of the present invention can include one or more vibrating devices which can function to impart a vibration onto each of the outer wall and the plurality of cutting elements, in order to assist a user to easily cut a cake using the device without otherwise damaging the cake.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of the whole cake cutting device that is useful for understanding the inventive concepts disclosed herein.

FIG. 2 is cutout side view of a cutting element of the whole cake cutting device, in accordance with one embodiment of the invention.

FIG. 3 is another perspective view of the whole cake cutting device in accordance with one embodiment of the invention.

FIG. 4 is a perspective exploded parts view of the whole cake cutting device, in accordance with one embodiment of the invention.

FIG. 5 is a perspective view of the whole cake cutting device in accordance with another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

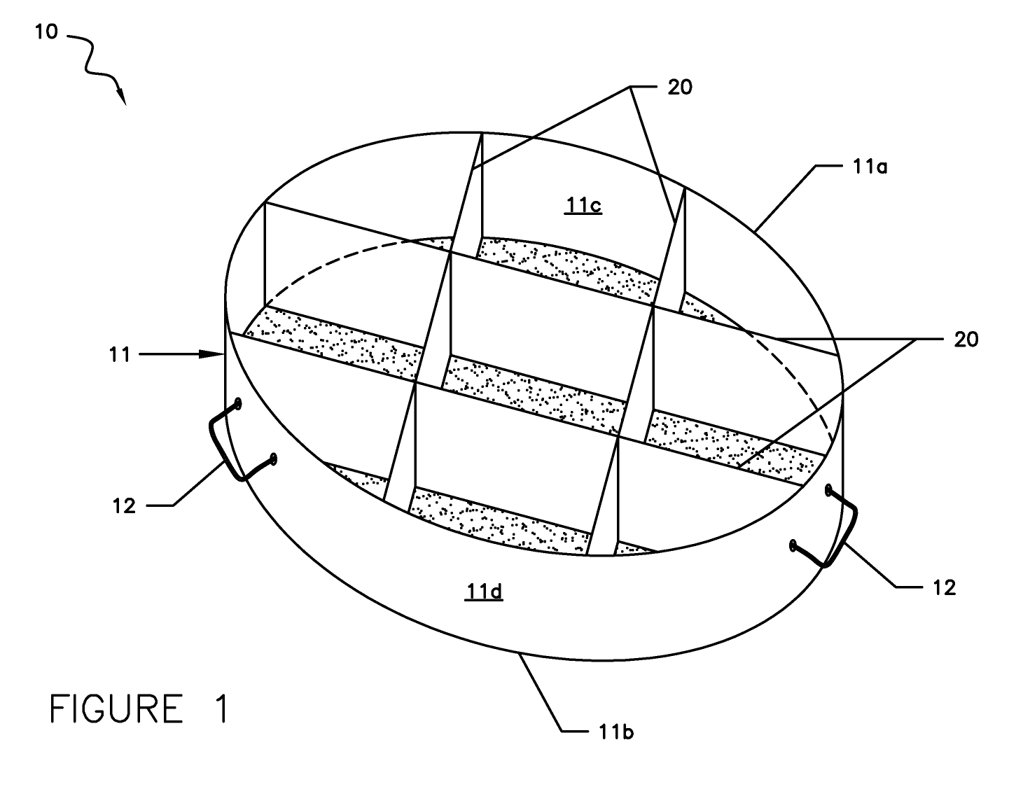

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIGS. 1-5 illustrate one embodiment of a whole cake cutting device 10 that is useful for understanding the inventive concepts disclosed herein.

The device 10 can include an outer wall 11 having a shape and size that is complementary to a shape and size of a whole cake to be cut. For example, FIG. 1, illustrates one embodiment of the device 10 wherein the outer wall 11 includes a generally circular shape defining a hollow interior that has no top wall or bottom wall. As shown, the outer wall 11 can include a top edge 11a, a bottom edge 11b, an inside facing surface 11c and an outside facing surface 11d.

One or more gripping devices such as the handles 12 can be disposed along the outside facing surface. The handle can serve the dual function of providing a convenient means for carrying the device, and can also provide a location for a user to impart a downward pushing force onto the device when cutting a cake.

In the preferred embodiment, the outer wall 11 can be constructed from a sturdy and generally heavy material such as stainless steel, for example, which can be reusable and wherein the weight of the outer wall can assist the user by requiring less downward force when cutting a cake. Of course, any number of other materials are also contemplated. In this regard, the main body 11 can be constructed from virtually any material that is suitable for making contact with food, such as injection molded plastic, for example.

A plurality of cutting elements 20 can be secured along the inside facing surface 11c of the device 10. In one embodiment, each of the cutting elements can be cross connected within the perimeter of the outer wall 11, so as to create a template for cutting several pieces of cake. By arranging the cutting elements in a cross connected manner, the device is able to cut the entire cake into several sections, that do not stretch from the middle of the cake all the way to the edges.

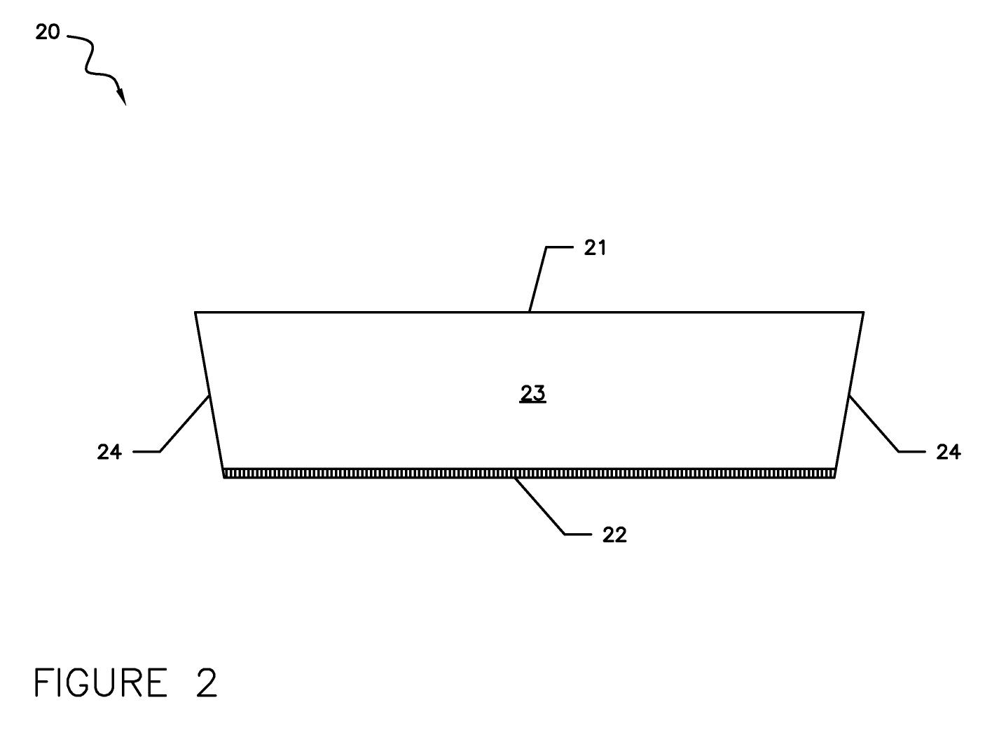

FIG. 2, is a cutout view of a single cutting element 20, in accordance with one embodiment of the device. As shown, the cutting element 20 can include a top edge 21, a sharp bottom knife edge 22, a middle wall section 23 and a pair of opposing ends 24. As shown, the bottom surface can include a sharp cutting surface and may include serrations. The cutting element can include a height (measured from the bottom edge 22 to the top edge 21) that is substantially identical to the height of the outer wall 11.

In one preferred embodiment, the main body 11 and the cutting elements 20 can include a unitary construction wherein each element is constructed from stainless steel having a nonstick coating such as Teflon®, for example, in order to prevent damage to the cake during the cutting procedure. Of course, any number of other materials are also contemplated. In this regard, each of the cutting elements 20 can be constructed from any number of suitable materials such as steel or plastic, for example, and can be the same or different than the material of the outer wall 11 to which the cutting element(s) are attached.

In operation, the device 10 can be positioned over the top of a cake or other such confection, and a downward force can be applied to the device. At this time, the cutting elements 20 can function to slice through the cake, resulting in several perfectly cut pieces, each having the desired shape and size.

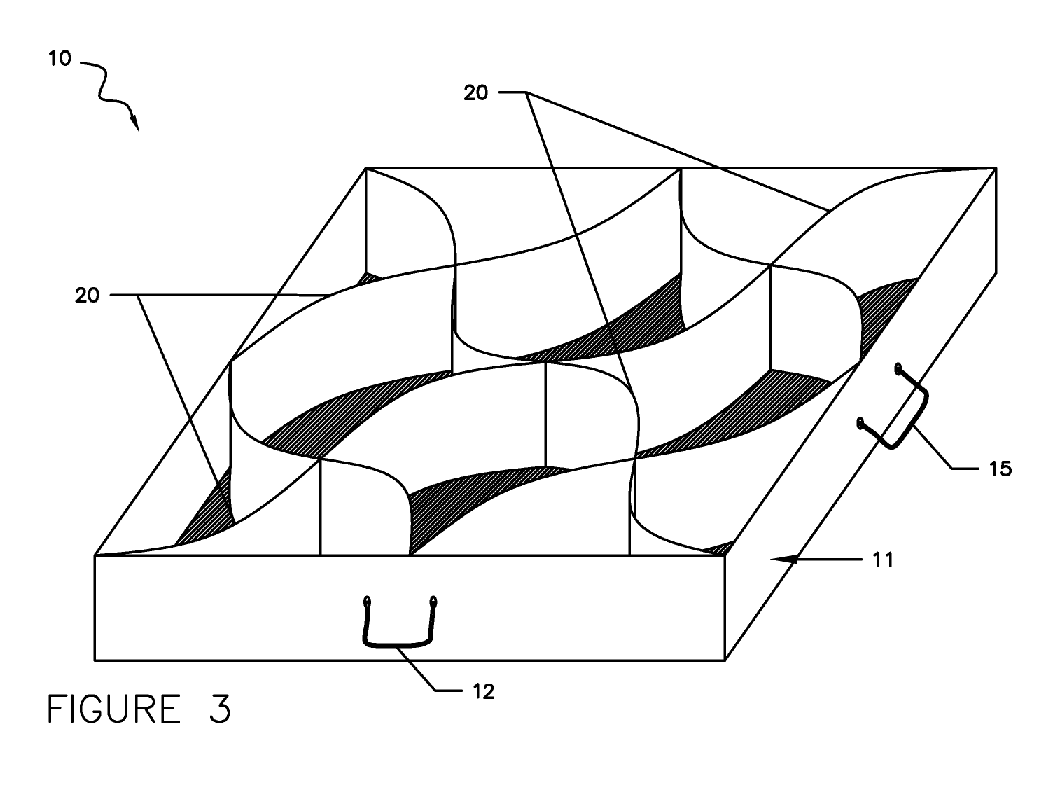

Although illustrated above with respect to a circular outer wall, and a plurality of straight, cross mounted cutting elements, the inventive concepts are not to be construed as limiting to any particular shape, height or dimension. As illustrated in FIG. 3, the device 10 can include any number of different shaped outer walls such as square and rectangular, for example, depending on the shape and size of the cake to be cut. Moreover, the device 10 can also include any number of different sized and shaped cutting elements 20 such as wavy and curved, for example, that can be secured onto the outer wall 11 in any number of different configurations, depending on the desired look and shape of each piece of the cake to be cut.

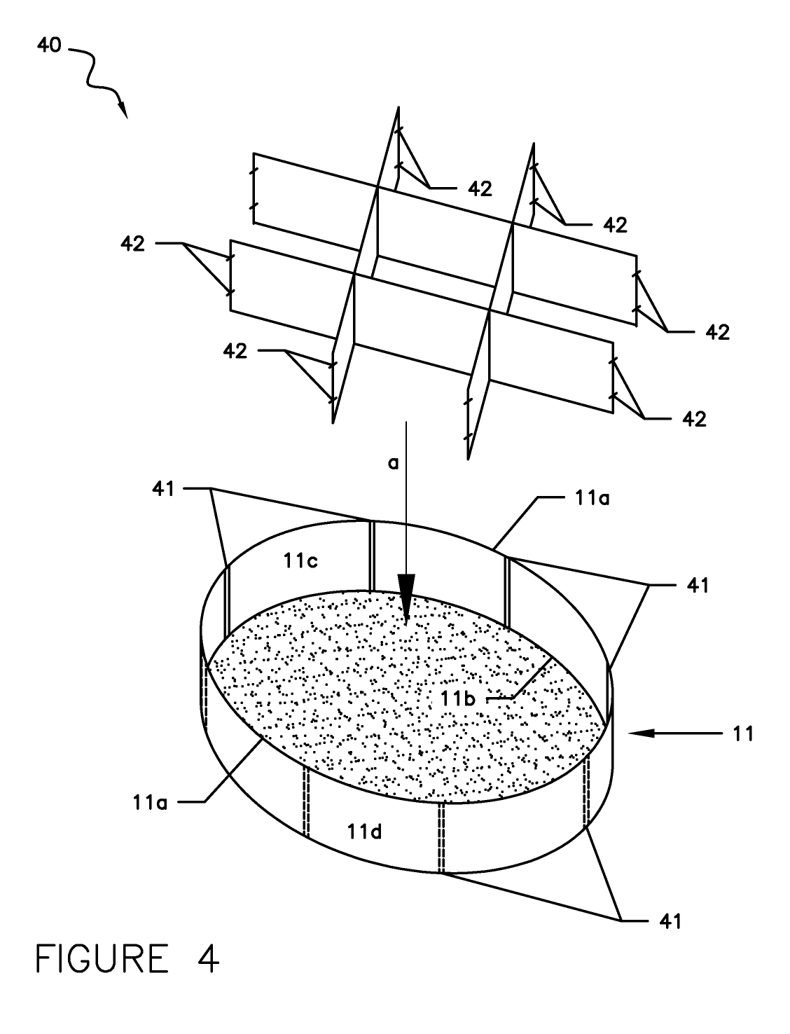

FIG. 4 illustrates another embodiment of the device 10, wherein each of the cutting elements 20 can be removably secured to one another and/or the outside wall 11. In such an embodiment, the inside surface 11c of the wall 11 can include a plurality of vertical channels 41, and each end 24 of each of the cutting elements 20 can include one or more protrusions 42 for engaging the channel 41 via a sliding motion (See arrow a). Such a feature can allow a single outside wall 11 to be utilized with a plurality of different shaped and sized cutting elements 20 having either the same construction material or a different construction material. For example, a single outer body 11 could work with one set of cutting elements 20 which can be arranged to cut 6 wavy pieces of cake, or could work with a different set of cutting elements which could be arranged to cut twelve smaller pieces of cake, each having a round shape.

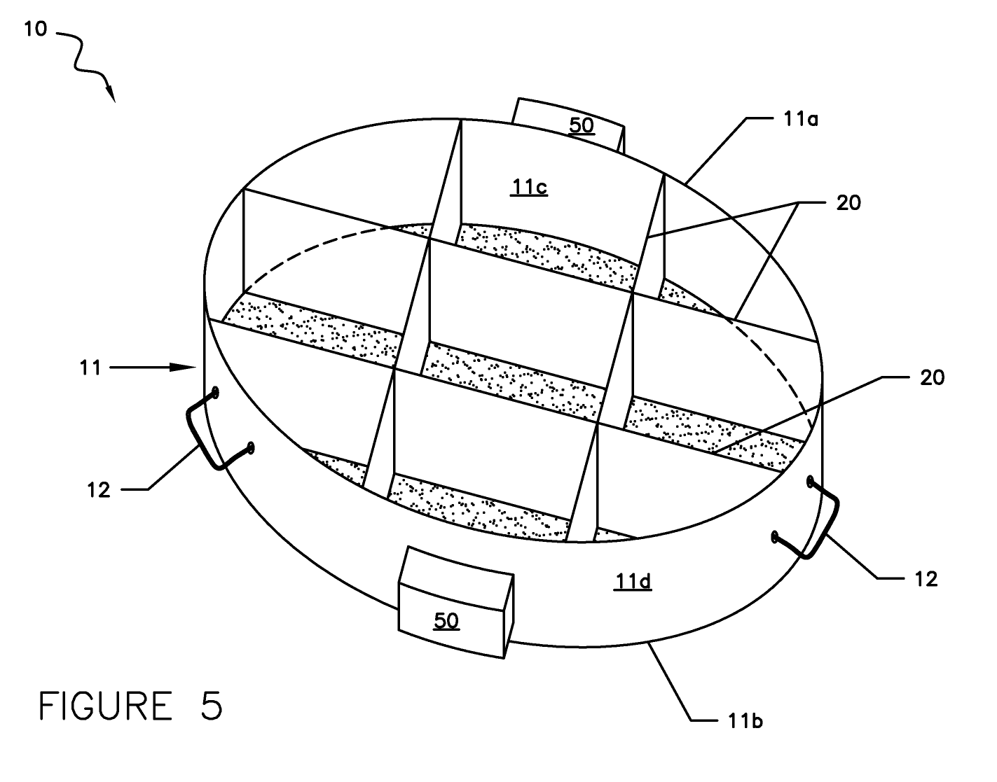

FIG. 5 illustrates another embodiment of the whole cake cutting device 10 wherein one or more small, battery powered vibrating devices 50 can be secured directly onto the outside facing surface of the outer wall 11d. Each of the devices including a vibrating motor that can function to impart a vibrating force onto the outer wall 11, and onto each of the cutting elements 20. Such a feature can result in a slicing motion that can assist the knife edge 22 of the cutting elements to smoothly cut through the cake, frosting and other such features in a controlled manner, and without requiring the device user to impart a significant amount of downward force which could ultimately cave in the surface of the cake.

Several examples of a suitable battery powered vibrating motor include any number of commercially available disk motors, brick buzzers and micro pager motors, for example. The components, use and operation of these devices being extremely well known in the art, therefore no further description will be provided.

Accordingly, the above described whole cake cutting device provides a novel approach to creating a plurality of evenly sized and uniquely shaped pieces of a cake or other such confections.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A cake cutting device, comprising:
a continuous outer wall that includes a top edge, a bottom edge, an inside facing surface and an outside facing surface that define a hollow interior space; and
a plurality of cutting elements that are disposed within the hollow interior space, each of said cutting elements being secured to the inside facing surface of the outer wall and arranged in a cross connected orientation.

2. The device of claim 1, wherein each of the plurality of cutting elements includes a top edge, a sharp bottom knife edge, a middle wall section and a pair of opposing ends.

3. The device of claim 2, wherein each of the plurality of cutting elements includes a generally straight shape.

4. The device of claim 3, further comprising:
a plurality of serrations that are disposed along the bottom knife edge of each of the plurality of cutting elements.

5. The device of claim 2, wherein each of the plurality of cutting elements includes a wavy shape.

6. The device of claim 5, further comprising:
a plurality of serrations that are disposed along the bottom knife edge of each of the plurality of cutting elements.

7. The device of claim 1, wherein each of the continuous outer wall and the plurality of cutting elements are constructed from a unitary piece of stainless steel.

8. The device of claim 1, wherein each of the plurality of cutting elements are removably secured to the continuous outer wall.

9. The device of claim 1, wherein each of the outer wall and the plurality of cutting elements are constructed from an identical material.

10. The device of claim 1, wherein each of the outer wall and the plurality of cutting elements are not constructed from an identical material.

11. The device of claim 1, wherein the continuous outer wall includes a generally circular shape.

12. The device of claim 1, wherein the continuous outer wall includes a generally rectangular shape.

13. The device of claim 1, further comprising:
one or more handles that are disposed along the outside facing surface of the continuous outer wall.

14. The device of claim 1, further comprising:
One or more battery powered vibrating devices that are secured onto the continuous outer wall, each of said vibrating devices functioning to impart a vibrating force onto the continuous outer wall and the plurality of cutting elements.
